(19) United States
(12) Patent Application Publication
(10) Pub. No.: US 2007/0023359 A1
(43) Pub. Date: Feb. 1, 2007

(54) Methods of the purification and use of moderately saline water particularly for use in aquaculture, horticulture and, agriculture

(76) Inventor: Gerald J. Grott, Phoenix, AZ (US)

Correspondence Address: DRUMMOND & DUCKWORTH, Suite 500, 4590 MacArthur Blvd., Newport Beach, CA, 92660, US

(21) Appl. No.: 11/495,979

(22) Filed: Jul. 28, 2006

Related U.S. Application Data
(60) Provisional application No. 60/703,916, filed on Jul. 29, 2005.
(60) Provisional application No. 60/721,410, filed on Sep. 28, 2005.
(60) Provisional application No. 60/733,109, filed on Nov. 2, 2005.

(51) Int. Cl. C02F 1/42

(52) U.S. Cl. 210/670; 210/685

(57) ABSTRACT

The invention relates to purifying unwanted moderately saline water. The methods of the present invention including passing moderately saline water through an ion exchange media saturated with ammonium salts to produce fertilizer water. In addition, the present invention relates to a method of passing moderately saline water through a dual bed cation and anion exchange process for producing purified water. The first cation exchange media is saturated with acids of hydrochloric, nitric or sulfuric acids. Meanwhile, the second ion exchange media is saturated with ammonium hydroxide. Passing the moderately saline water through the first ion exchange media creates an acid rich water which is then passed through the second ion exchange media to remove chloride, sulfate, nitrate, and nitrite anions. Through a regenerative cycle, a fertilizer water is produced which is rich in ammonium chloride, ammonium nitrate or ammonium sulfate.

### BACKGROUND OF THE INVENTION

The present invention relates to methods for purification of water containing dissolved salts. In addition, the present invention relates to uses of the effluents produced from water purification of moderately and substantially saline water.

There is an ever increasing need for additional water for domestic and industrial use, and particularly for aquaculture, horticulture and agricultural growth. Ironically, there is also an ever increasing need for disposal of saline waste water. For example, 50,000 acres of irrigated land in the Inperial Valley have been idled to allow for the sale of the irrigation water for use in San Diego. Thousands of acres of agricultural land in the San Joaquin Valley have been idled and the plan is to idle 10's of thousands of additional acres because of the lack of water. The supply of water has decreased by the contamination of groundwater supplies by salty waste waters from industry and agriculture. In the San Joaquin Valley of California irrigated agriculture produces an estimated 2 million acre feet per year of drainage containing 6 million tons of salts that are brought into the lower San Joaquin Valley with water “imported” for use in irrigation. Plant use of water and evaporation concentrates these salts in drainage produced by leaching excess sodium. This drainage moves down-slope and accumulates because there is no exit. An additional 1.4 million tons of salts per year are contained in saline waste water flowing into the Salton Sea. Meanwhile the United States Geological Survey recently determined that New Mexico has an astounding 15 billion acre feet of brackish ground water, and a single basin in West Texas was found to have 760 million acre of brackish ground water.

The disposal of saline water has also become an expensive problem for the oil industry. For example, approximately 1.61 billion gallons of water containing approximately 80,000 tons of mixed sodium, calcium, magnesium chlorides and sulfates is produced from water treatment operations and oil fields in the state of California alone. This saline water must be disposed of, costing the oil producers in the state of California millions of dollars each year.

Meanwhile, the disposal of waste water has become even more problematic in other parts of the world. As a result, billions of dollars are spent each year toward efforts to dispose of waste waters. Accordingly, it would be highly advantageous to provide improved methods of disposing of salty waters. It would even be more advantageous to provide methods of utilizing salty waters which provide a benefit to society, instead of simply disposing of the unwanted waters.

Ironically, though there is an overabundance of waste waters that are contaminated with the salts of Na, K, Ca, Mg, Fe, Cl, SO₄, and CO₃ that are extraordinarily expense to dispose of, billions of dollars are spent each year on salts such as sodium chloride. World use of the principal inorganic salts found in salty inland waters exceeds 300,000,000 tons/year. World demand for usable water is rapidly increasing the use of desalination processes which separate out salts, but the total of salts separated by desalting has remained only a small fraction of world use.

Still an additional problem encountered in agriculture is that soil is often too high in sodium and/or too high in salinity. Farmland and irrigation water is often unacceptably high in sodium. Irrigation waters containing high amounts of sodium salts versus calcium and/or magnesium salts can create a buildup of sodium in the soil. This excess soil results in the dispersion of soil colloidal particles and an increase in soil pH. The dispersion of colloidal particles causes the soil to become hard and compact when dry and increasingly resistant to water infiltration and percolation. The sodium rich soil also becomes resistant to water penetration due to soil swelling when wet.

In fact, the World Bank and other reliable sources estimate that of all land ever irrigated, some 12-15% has been lost to contamination by high saline water tables and this loss continues to rise. There is a great need to stop this increase in land loss and also a need to reclaim the land already rendered unproductive through excessive salinity.

The total salinity of soil and irrigation water is also of concern. Salinity refers to the total salts within the water, with the significant positive ions (cations) in salinity being calcium, magnesium and sodium and the significant negative ions (anions) being chloride, sulfate and bicarbonate. All irrigation water contains some dissolved salts. When soil has a high content of dissolved salts, or the irrigation waters have sufficient salts to increase the salinity of the soil, the soil has the tendency to hold the water instead of releasing the water for absorption by plant roots by osmotic pressure. Even if the soil contains plenty of moisture, plants will wilt because they cannot absorb necessary water.

The term “salinity” includes the total of all salts in the water and all salts are not equally harmful. On examination of the quality of water used for irrigation it is found that, except for trace elements found in various localities, the only contaminants present in quantities large enough to be a deterrent to soil tilth and agricultural productivity are sodium salts. Thus, in most cases, desalination requires only the reduction of sodium salts, mostly as the chloride (and the sometimes removal of trace elements).

Known water purification processes proceed by numerous methods including ion-exchange, membrane softening, electrolysis, evaporation and precipitation. The softening of hard water take place by removing calcium and magnesium which is required for both industrial and household use. Known water softening processes proceed either by way of ion-exchange, membrane softening or precipitation. In the ion-exchange processes, the calcium (Ca²⁺) and magnesium (Mg²⁺) ions are exchanged for sodium (Na⁺) and the regeneration of the ion-exchange resin is achieved with a large excess of NaCl. This processes creates a regeneration effluent being a relatively concentrated aqueous solution of sodium, calcium and magnesium chlorides which has to be discarded. Consequently, by this method, considerable amounts of sodium, calcium and magnesium salts in solution must be disposed of.

Alternatively, it is possible to soften water by using weak acid resins which exchange hydrogen (H⁺) for calcium (Ca²⁺) and magnesium (Mg²⁺), and to regenerate the spent resins with a mineral acid. While this method creates less waste water, it is more expensive and yields relatively acidic soft water which is corrosive. Meanwhile, membrane softening concentrates the calcium salts, magnesium salts and salts of other divalent ions to produce waste waters which require costly disposal.

The precipitation process has traditionally been carried out by the “lime soda” process in which lime is added to hard water to convert water soluble calcium bicarbonate into water insoluble calcium carbonate. This process also results in waste water which is difficult to filter and requires cumbersome treatment.

My previously issued patent, U.S. Pat. No. 5,300,123 relates to the purification of impure solid salts. Even this process produces salty waste water which must be disposed of. My latter issued U.S. Pat. Nos. 6,071,411; 6,374,539 and 6,651,383 relate to the processing and utilization of processed waste waters. These processes preferably employ ion exchange, preferably using sodium chloride or sodium sulfate to alter the salt content of treated water. Moreover, the resulting salts, clean effluents and waste water effluents are useful for various applications including for the treatment of soils for improving dust control, soil stabilization, adjusting the soil's sodium adsorption ratio (SAR), and treating root rot.

Unfortunately, even with all of the various water treatment processes of the prior art, there are billions of gallons of waste water and moderately saline water that are discarded or not utilized because it is far to expensive to purify such waters using known water treatment processes. This overabundance of water is troubling because there is an overwhelming world-wide need for water, particularly for human and livestock consumption. A recent report from the United Nations states that more than 50 percent of the nations in the world will face water stress or water shortages by the year 2025. By 2050, as much as 75 percent of the worlds's population could face water scarcity.

Water is also in great demand for soil treatment, particularly for irrigation. Unfortunately, waste waters typically have sodium content which is not suitable for nearby irrigation. Thus, it would be extraordinarily advantageous if an inexpensive process were developed for processing waste waters to produce an effluent suitable for irrigation.

Wind erosion of soil is also a significant problem throughout the world. Due to small particle size and poor cohesion, finely divided soil is sensitive to the influence of wind. Such finely divided soil is found in agricultural lands, dunes, lake beds, construction sites and roads under construction. Erosion by wind causes the drifting of masses of soil in the form of dust. The erosion by wind causes the inconvenience of dust formation and the loss of valuable matter such as seed, fertilizer and plantlets. Dust storms are a danger to traffic and a health risk to persons located in the vicinity.

Moreover, the effects of wind erosion on soil can be enhanced by the influence of the sun and rain. The sun causes the evaporization of moisture from soil thereby reducing the cohesion of finely divided soil. Erosion of the soil by rain is caused by rain washing away soil. This is a particular problem when agricultural soil is washed away, damaging plant life and making the soil unusable for agricultural purposes. Further, due to the influence of erosion by rain, the unprotected slopes of ditches, channels, dunes and roads may collapse or be washed away.

Therefore, it is extremely important to prevent the effects of the sun, wind and water in eroding soil. As used herein, soil stabilization refers to the treatment of soils with chemicals to offset the tendencies of soils to be sensitive to small changes in the types of ions in the soil moisture as they effect the plasticity of the soil. For example, swelled clays, those with layers of “bound” water molecules, are more susceptible to movement under load. Soil stabilization of swelled clays can be effected by altering the types and/or amounts of ions in the soil mixture.

Also, there is a serious problem because high crop yields require high levels of available nitrogen dissolved in the soil moisture. But the leaching necessary to reduce the sodium content of soils and soil moisture also removes the nitrogen. The nitrogen value is not only lost, the nitrogen becomes a pollutant. Therefore, it would be highly beneficial if the nitrogen in the irrigation drainage created by leaching excess sodium could be recycled to the fields. Additionally, it would be even more advantageous if the sodium content of irrigation water was reduced so that less sodium reaches the fields so that the less water needs be used for leaching and less nitrates will need to be recycled. Currently, there is no practical method to do this.

Meanwhile, the world production of ammonia ranges about 115-118,000,000 metric tons/year of which about 85% is used as fertilizer. Making ammonia uses natural gas at the rate of 33,000,000 BTU/ton of ammonia. All of the carbon in the natural gas is converted to carbon dioxide which is discharged into the atmosphere.

Ammonium containing fertilizers are commonly applied in the form of extremely volatile anhydrous ammonia, as aqueous ammonium (ammonium hydroxide) with a high vapor pressure of ammonium, or as fertilizers with a very low vapor pressure of ammonium as manufactured by mixing anhydrous ammonia or aqueous ammonium with selected acids to produce, for example, ammonium chloride, or ammonium nitrate, or ammonium sulfate.

Unfortunately, a high percentage of the anhydrous ammonia used in agriculture escapes to the atmosphere. Thus, it would also be highly advantageous if the anhydrous ammonia could be economically converted to the form of a salt with lower ammonium vapor pressure, like a chloride, nitrate, or sulfate that is commonly used to minimize vapor losses even though these forms are more costly.

Further, it would be highly desirable that, in addition to the simple removal of unwanted salts, that practices for desalination provided for the recovery of calcium, magnesium, and the nitrogen compounds in a form suited for recycling to irrigation or other uses, including forms that allow efficient transport to other localities and markets.

It would also be highly desirable to provide a method for treating soil that is of low cost and utilizes a material or compound which is readily available. It would be even more advantageous if salty waste waters could be processed to produce waters useful to irrigate or fertilize soil, or could be used to control dust and effect soil stabilization.

Moreover, it would be desirable to provide a method of maintaining the proper salinity levels and salinity equilibrium in soil to enhance the agricultural properties of soil.

In addition, it would be very beneficial if a way were found to exchange ammonium ion for sodium so that salty water would become a solution of fertilizers.

Finally, it would be desirable if all of the aforementioned objectives could be accomplished while overcoming the expensive and problematic concerns facing this country and the rest of the world, specifically, the disposing of saline waters. It would further be desirable if this objective could be obtained while simultaneously meeting the above described needs.

### SUMMARY OF THE INVENTION

Briefly, in accordance with the invention, I provide methods for economically and efficiently purifying moderately saline waters to provide useful water, particularly useful for applying to soil such as for crop irrigation. As defined herein, moderately saline waters are defined as waters having 0.05% or more by weight of the salt of Na, K, Ca, Mg, Fe, Cl, SO₄, or CO₃, or combinations thereof.

The moderately saline water is passed through an ammonium saturated resin in a cation exchange process that substitutes the ammonium for sodium. The resulting effluent has decreased sodium cations and increased ammonium cations compared to the untreated moderately saline water. This treated water, also referred to herein as a “fertilized water” has a high ammonium and nitrogen content but a sodium absorption radio (SAR) of nearly zero. Accordingly, this fertilized water is ideally suited for applying to soil for irrigating crops.

In a preferred embodiment, prior to passing the moderately saline water through the ammonium saturated resin, the moderately saline water is softened through any of numerous water softening methods known to those skilled in the art. The water softening results in the moderately saline water having an increased sodium content, but decreased calcium and magnesium content.

As moderately saline water passes through the ammonium saturated ion exchange media, the sodium content of the ion exchange media will increase and the ammonium content will decrease. Accordingly, it is preferred that the ion exchange media is periodically regenerated by flushing the ion exchange media with a regenerative solution having more than 1% by weight of ammonium salts, and preferably having 7-15% or more by weight of ammonium salts.

In an additional preferred embodiment of the invention, a dual bed cation and anion exchange system is provided. This embodiment includes a first ion exchange vessel wherein the ion exchange resin is saturated with hydrogen from hydrochloric, nitric or preferably sulfuric acid. As moderately saline water passes through the cation exchange resin, the hydrogen is exchanged for sodium. Thereafter, the acid rich water is passed through a second vessel providing an anion exchange. The hydroxyl anion is exchanged for chloride, sulfate, nitrate, and nitrite anions removing them from the water passing through the anion exchange bed of resin. The hydrogen in the water from the cation exchange and hydroxyl anion entering the water, in exchange for the chloride, sulfate, nitrate, and nitrite anions, combine to form water. Thus, the product water is highly purified, typically with 96-99% removal of salts, which depending on trace cation levels, the resulting effluent may be of sufficiently high quality to be use for animal, including human, consumption.

Ultimately, the dual bed deionizers must be regenerated. Once the first ion exchange resin has become saturated with sodium ions, the resin is flushed with a regenerative solution of more than 1% hydrochloric, nitric or sulfuric acid, though 7-15% or more is preferred. Meanwhile, the second ion exchange is preferably flushed with a second regenerative solution containing more than 1% of ammonium hydroxide, and preferably 7-15% or more by weight of ammonium hydroxide. The anion resin is regenerated with a solution of ammonium hydroxide which exchanges hydroxyl anions from the anion exchange resin to form ammonium rich water having increased ammonium chloride, ammonium nitrate or ammonium sulfate, depending on the acid employed. This “fertilizer rich” water is rich in ammonium salt and is ideally suitable for irrigation and other industrial applications.

Advantageously, all of the resulting effluents including those created from the regeneration cycle may be utilized to treat soil, such as for irrigation, treating root rot, dust control, etc., or for other industrial uses.

Accordingly, it is an object of the invention to provide cost effective means of processing moderately saline waters.

It is a also principal object of the invention to provide new methods for utilizing the useful water produced from water purification.

These and other, further and more specific objects and advantages of the invention will be apparent to those skilled in the art from the following detailed description taken in conjunction with the drawings.

### BRIEF DESCRIPTION OF THE DRAWINGS

FIG. 1 is a flow chart illustrating a preferred method of water purification and water use of the present invention;

FIG. 2 is an additional flow chart illustrating an additional preferred method of water purification and water use of the present invention;

FIG. 3 is a flow chart illustrating a method of “air stripping” ammonium;

FIG. 4 is a flow chart illustrating an additional method of “air stripping” ammonium;

FIG. 5 is a flow chart illustrating still an additional method of “air stripping” ammonium;

FIG. 6 is an additional flow chart illustrating a preferred embodiment of the present invention utilizing a dual bed cation and anion exchange;

FIG. 6 is an additional flow chart illustrating a preferred embodiment of the present invention utilizing a dual bed cation and anion exchange with sulfuric acid and ammonia;

FIG. 7 is an additional flow chart illustrating a preferred embodiment of the present invention utilizing a dual bed cation and anion exchange with hydrochloric acid and ammonia;

FIG. 8 is an additional flow chart illustrating a preferred embodiment of the present invention utilizing a dual bed cation and anion exchange with nitric acid and ammonia; and

FIG. 9 is an additional flow chart illustrating a preferred embodiment of the present invention wherein the dual bed cation and anion exchange system uses nitric acid and ammonia to produce water that is applied to soil for crops where added sodium is beneficial to the soil;

FIG. 10 is an additional flow chart illustrating a preferred embodiment of the present invention wherein the dual bed cation and anion exchange system uses sulfuric acid and ammonia to produce water that is applied to calcareous soil;

FIG. 11 is a flow chart illustrating an additional method of “air stripping” ammonium; and

FIG. 12 illustrates an acceptable modified Solvay Process.

### DETAILED DESCRIPTION OF THE INVENTION

While the present invention is susceptible of embodiment in various forms, as shown in the drawings, hereinafter will be described the presently preferred embodiments of the invention with the understanding that the present disclosure is to be considered as an exemplification of the invention and it is not intended to limit the invention to the specific embodiments illustrated.

Briefly, in accordance with the invention, I provide methods for economically and efficiently processing moderately saline waters, particularly those produced from oil and brackish ground water, domestic sewage water, gas wells, and irrigation drainage, to produce an effluent containing lower sodium content but having an increased ammonia content. I also provide methods for utilizing the effluent produced by water purification.

The process of the present invention provides for treating saline water typically having 0.05% or more by weight of the salts of Na, K, Ca, Mg, Fe, Cl, SO₄, or CO₃ or combinations thereof. The present invention is particularly suitable for treating water having high sodium content. The saline water is then passed through an ion exchange resin in an cation exchange process to produce “useful water”. Even more particularly, the ion exchange resin is saturated with ammonium ions to effect an ammonium for sodium exchange. As defined herein, the term “saturated” is interpreted in a loose sense to mean that the ion exchange media has sufficient ammonium cations to effect ion exchange for sodium to reduce the amount of sodium in the saline water.

Contrary to industry experience and advice that ammonium is not economically efficient to reduce sodium in ion exchange processes, we have found that Chabasite, a group of minerals of the zeolite family consisting of a hydrous silicate of calcium and aluminum is effective. A preferred Chabasite can be obtained from GSA Resources. Other ion exchange resins, such as synthetic zeolite, may also be useful.

Cation exchange resins and zeolites are often sold saturated with sodium which is unacceptable for practicing the present invention. To saturate the resin with multivalent cations, ammonium salts are utilized to flush the resin until the resin is sufficiently saturated with ammonium cations to effect an ion exchange for sodium. A preferred ammonium salt is ammonium chloride. Once saturated, the resin is preferably rinsed with low saline water to remove unused ammonium chloride.

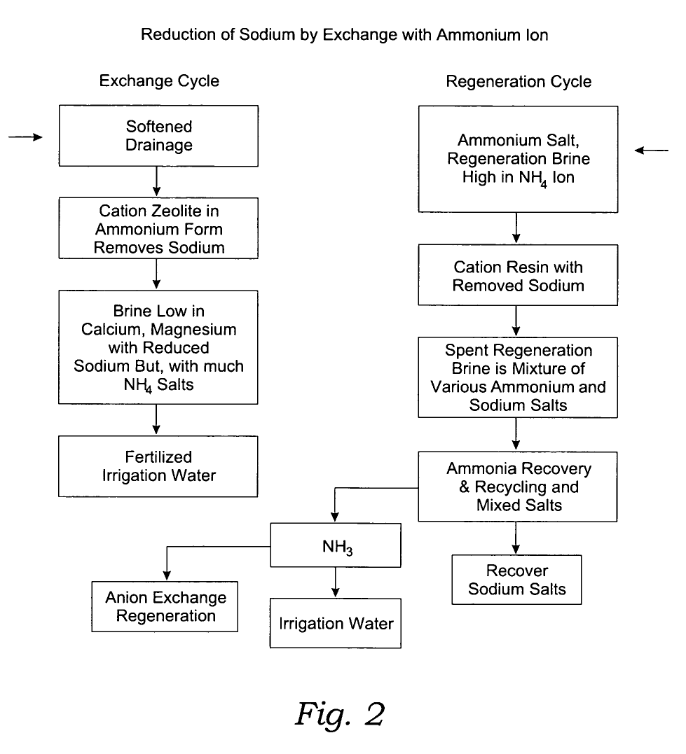

With reference to the first column of FIG. 2, moderately saline water, particularly saline water high in sodium, is passed through the ammonium saturated resin in an cation exchange process that substitutes the ammonium for the sodium to produce a useful effluent having decreased sodium cations and increased ammonium cations compared to the untreated saline water. The effluent is a form of “fertilized water” having a high ammonium and nitrogen content but a sodium adsorption ratio (SAR) of nearly zero. As understood by those skilled in the art, the SAR is the amount of ion exchange sites that would be occupied by sodium based on the amount of calcium and magnesium present. As the result of the fertilized water's low sodium content and high ammonium and nitrogen content, it is ideally suited for irrigating crops and treating soil.

As the moderately saline waters passes through the ion exchange resin, the sodium content of the resin rises and the multivalent cation content lowers until the resin is unacceptable for further water treatment in accordance with the present invention. With reference to column 2 of FIG. 2, to regenerate the ion exchange resin, the resin is again flushed with an ammonium salt solution in a regenerating process. Preferably, the ammonium salts in the solution are the chloride, sulfate, or nitrate forms and contain more than 1% of the salts by weight. The solution is flushed through the ion exchange resin until the amount of multivalent cations affixed to the ion exchange resin is increased and the sodium affixed to the resin is decreased until the ion exchange resin is sufficiently saturated with ammonium ions to again process water having high sodium content.

The regeneration process increases the ammonium ions in the bed of ion exchange resin. However, the effluent produced may be high in various calcium, magnesium, and sodium salts depending on whether the water was softened before the ion exchange, as in the preferred process, and according to which ammonium fertilizer salt, or mix of ammonium fertilizer salts, were used in the regeneration of the resin bed. The spent regeneration brine, after having been stripped of the ammonium, finds uses as described in my previous patent application Ser. No. 11/061,536, filed Mar. 16, 2005 and Ser. No. 10/706,341 filed on Nov. 11, 2003 and issued U.S. Pat. No. 6,651,383, U.S. Pat. No. 6,374,539 and U.S. Pat. No. 6,071,411 which are all incorporated by reference herein.

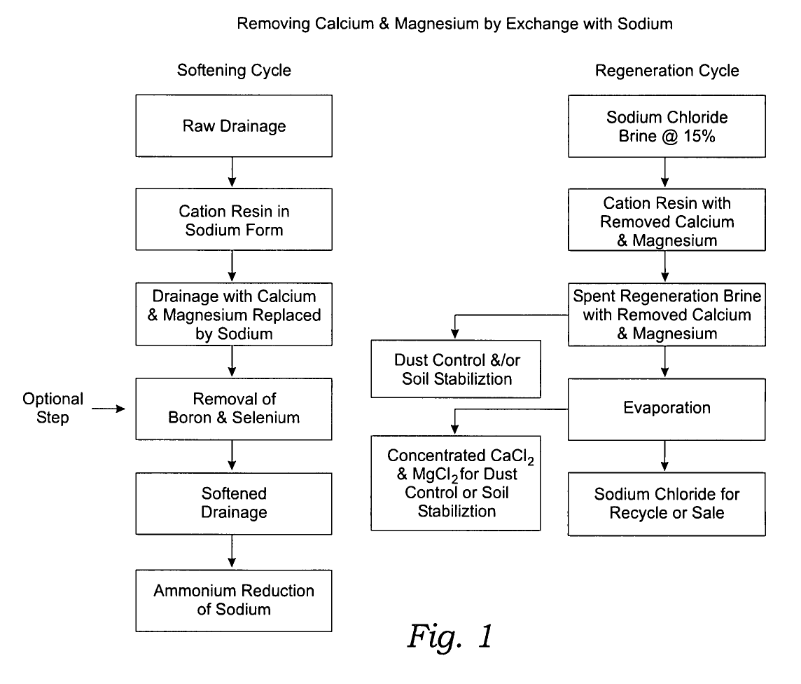

In a preferred and more expansive embodiment of the invention, with reference to the first column of FIG. 1, preferably the untreated saline water is “softened” prior to desalination through the ammonium cation exchange processing step. Water softening is the removal of the “hardness” from the water which means predominantly removing or altering the calcium and magnesium ions from the water. Several methods for effecting water softening are known. The best known process for softening water is “ion-exchange”. The hard water passes through a tank containing an ion exchange resin, often containing beads which are microporous. The beads are saturated with sodium to cover both their exterior and interior surfaces. As the water passes through the resin, an ion exchange process occurs. Ion-exchange entails the exchange of sodium, which is introduced into the water from the resin, for calcium, magnesium, iron and other divalent mineral ions which are transferred out of the water and into a resin. Calcium and magnesium ions attach to the resin while the sodium on the resin is released into the water. Where the treated water is to be used for application to soil for irrigation, the effluent may also undergo an additional treatment step wherein the boron and selenium are removed.

With reference to the second column of FIG. 1, when the resin approaches saturation with these hard ions, the resin is regenerated, preferably with 10% or more of solutions of sodium chloride leaving an effluent containing 3 to 25% sodium, calcium and magnesium salts which must be disposed of. The spent regeneration brine, particularly after ammonium stripping, may be applied to soil to effect dust control, effect soil stabilization, and effect soil sealing, or within cooling towers. Alternatively, the brine may undergo an evaporation process to produce concentrates of calcium, magnesium, and/or sodium salts for use or sale.

With reference again to the first column of FIG. 2, the softened water is passed through the ammonium saturated resin to substitute the ammonium for the sodium to produce a useful effluent having decreased calcium, magnesium and sodium cations and increased ammonium cations compared to the pre-softened saline water. This fertilized water is then applied to soil. Alternatively, the ammonium may driven off as a gas for recycling or for use as a fertilizer.

Meanwhile, with reference again to column 2 of FIG. 2, once the ion exchange resin has become saturated with sodium ions, the resin is again flushed with an ammonium salts of the chloride, sulfate, or nitrate forms. The flush continues until the ion exchange resin is sufficiently saturated with multivalent cations to again process water having high sodium content, preferably water that has been softened through a water softening process.

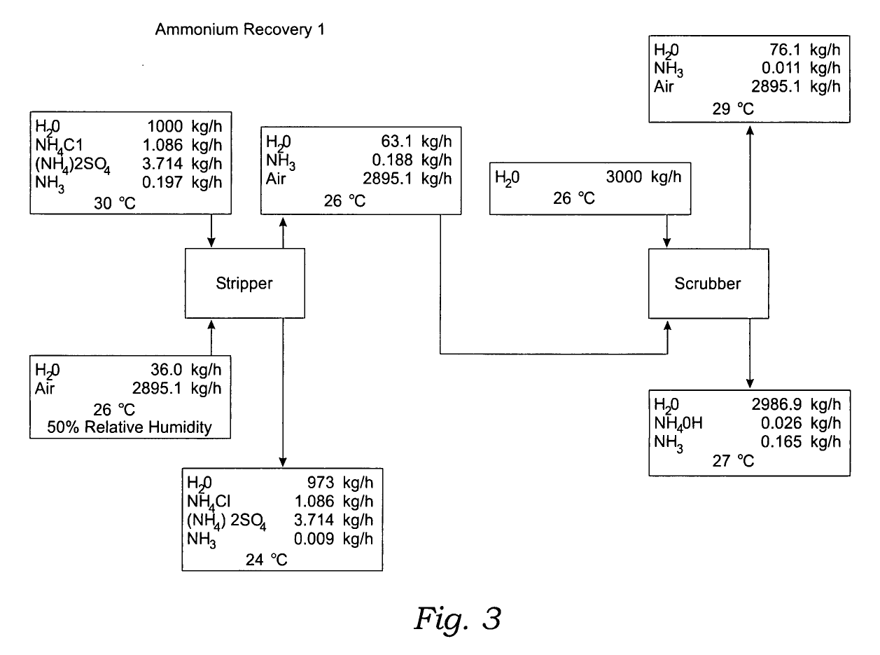

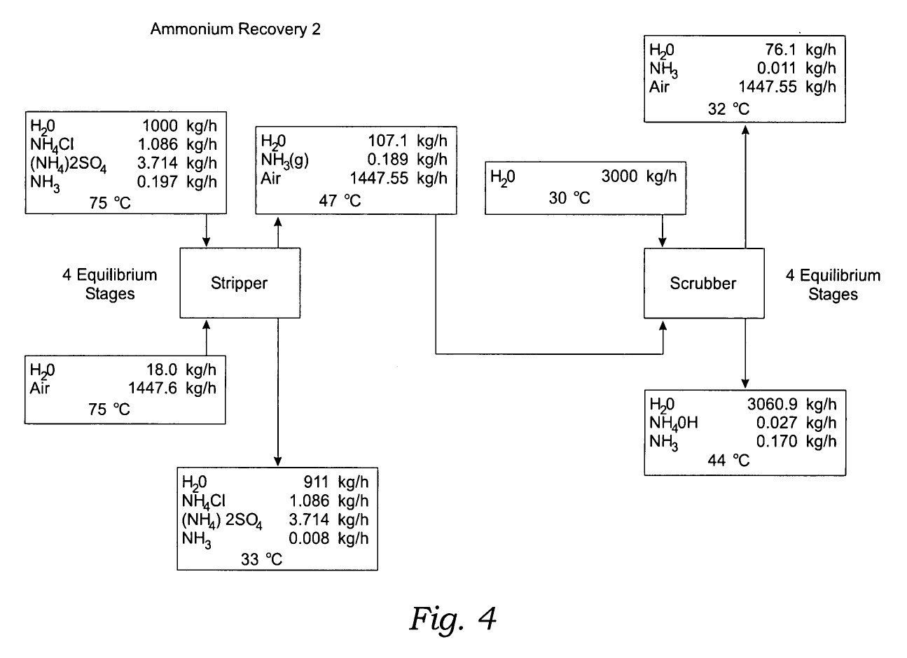

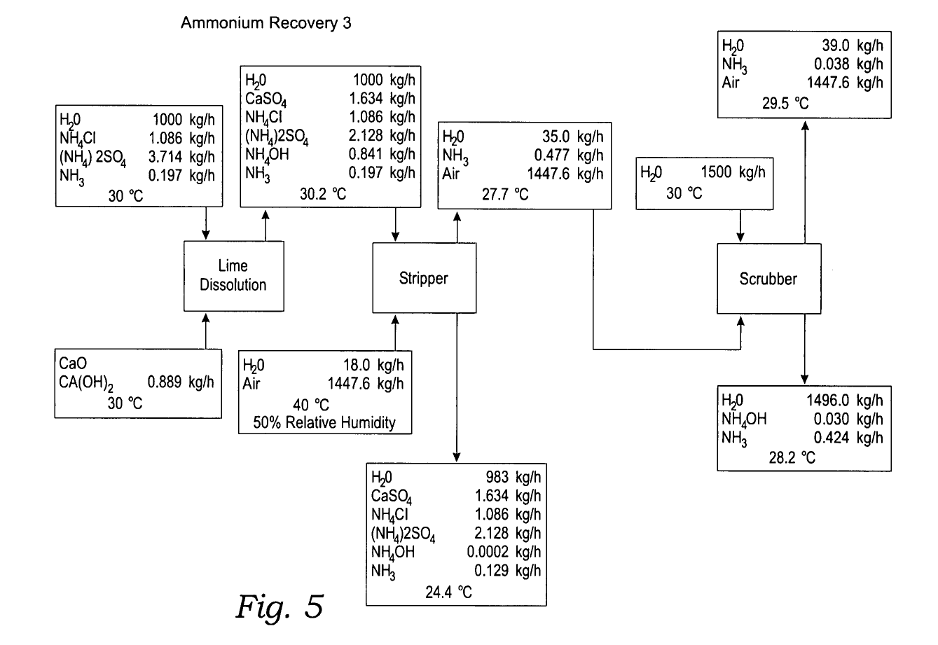

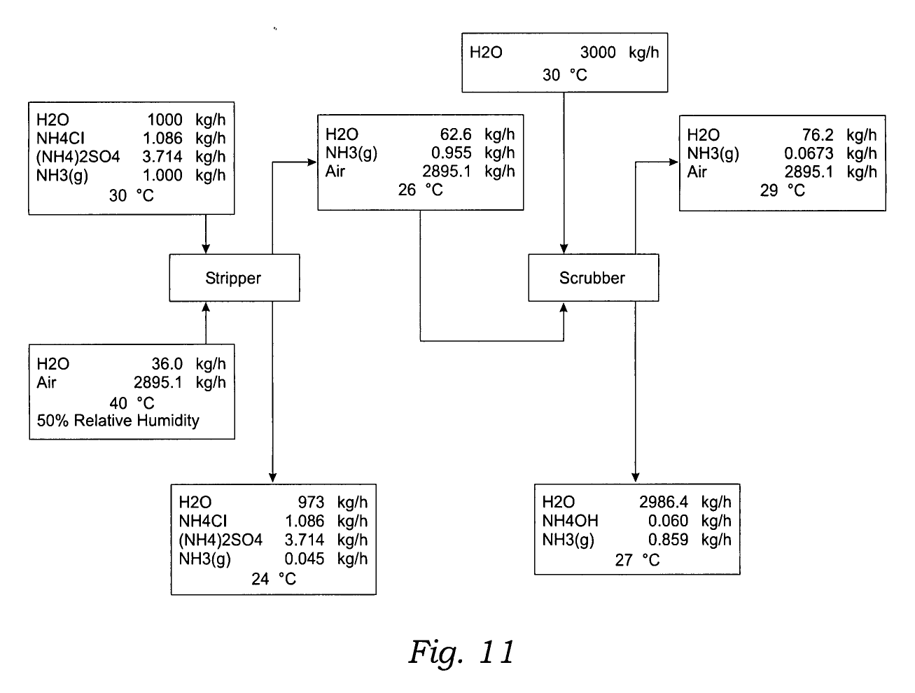

As an alternative to applying the “fertilizer water” directly to soil, the ammonium may be recovered from the fertilized water (see bottom of column 1, FIG. 2). In addition, the ammonium may be recovered from the spent regeneration brine (see bottom of column 2, FIG. 2). Presented as examples only, three processes for “air stripping” the ammonium high water are illustrated in FIGS. 3-5 and 11. Each of these Figures include computer generated calculations representing examples of distinctive air stripping processes. FIG. 3 illustrates a process wherein the effluent is stripped with an air-water mixture. Meanwhile, FIG. 4 illustrates an air stripping process wherein the effluent is stripped with an air-water mixture at 75 Celsius, as is typical of heat produced from non-convecting solar ponds. FIG. 5 illustrates an air stripping process wherein lime is added to assist in ammonium hydroxide recovery, which also produces usable calcium compounds. In each of these processes, one collects the ammonium in water to make a solution of ammonium hydroxide which can be used as fertilizer, as cleaning compounds, and for other well known uses of solutions of ammonium hydroxide. Ammonia may also be collected by a variety of media other than plain water such as: hydrochloric acid which will make ammonium chloride; sulfuric acid which will make ammonium sulfate; and carbonic acid which will make ammonium carbonate, etc. Air strippers, ammonium and ammonia collection processes are known to those skilled in the art and need not be discussed further herein.

Meanwhile, as an alternative to regenerating the spent regeneration brine (see bottom of column 2, FIG. 2), the spent regeneration brine containing unused ammonium and removed cations may be used in the fertilization of halophytes and in saline aquaculture for algae, fish, and shrimp.

The embodiment described above will now be further explained in and by the following examples.

### EXAMPLE 1

Irrigation drainage is obtained from the California Department of Water Resources from Red Rock Ranch, Westsides Resource Conservation District having the following properties. Notably, “ND” in the Example signifies “Not Detected” at the sensitivity of the analysis employed which is 5 mg/L for calcium and 10 mg/L for sodium.

As Received

| Analyte(s) | Result | Units |
|---|---|---|
| Cations | | |
| Calcium | 530 | mg/L |
| Magnesium | 110 | mg/L |
| Sodium | 1400 | mg/L |
| Anions | | |
| Sulfate | 2700 | mg/L |
| Chloride | 720 | mg/L |
| Metals and Metalloids | | |
| Boron | 14000 | ug/L |
| Molybdenum | ND | ug/L |
| Selenium | 220 | ug/L |

The received drainage water is softened by passing the drainage water through a strong acid cation resin of Lewatit C-249 from Sybron Chemicals, a division of Bayer Chemicals, which has been saturated with sodium. The softened water is analyzed to have the following properties.

As Softened

| Analyte(s) | | |
|---|---|---|
| Cations | Result | Units |
| Calcium | ND | mg/L |
| Magnesium | ND | mg/L |
| Sodium | 2200 | mg/L |

A resin of Chabasite is received from GSA in the natural form and reported to be primarily in the sodium form. A column of Chabasite approximately 39 inches high is first washed with water of less than 70 ppm TDS to remove fines and dirt. The column of Chabasite is then converted to the ammonium form by passing a 15% solution of ammonium chloride down the column, followed by the conventional down flow rinse cycle using low salinity water to remove unused ammonium chloride. The softened water is then passed through Chabasite resin column. As reflected in the following analysis, passing the drainage water through the column of Chabasite is highly effective in removing sodium.

As Treated

| Analyte(s) | Result | Units |
|---|---|---|
| Cations | | |
| Sodium | ND | mg/L |
| Nutrients | | |
| Ammonia-Nitrogen | 1300 | mg/L |

In summary, the process removes sodium from 2200 ppm before treatment to below the Detection Limit of the lab, 10.0 mg/1 RDL, Method EPA 200.7. After being treated, the drainage is a fertilized water with an extremely low sodium content.

The process of ammonium ion exchange to convert salty waters into fertilized waters provides a great number of uses. For example, ammonium can be used to remove calcium, magnesium, sodium and other cations from the drainage to get the same solution of fertilizers. This will be of great use in the direct conversion of brackish groundwater to fertilized water where USGS has documented huge volumes of brackish water as in New Mexico's 15 billion Acre Feet.

For salty water carrying substantial amounts of calcium and magnesium, as in the San Joaquin Valley and Imperial Valley of California, the preferred processes start with softening the drainage water. This separates the calcium and magnesium as chlorides which are quite valuable and can be used within a variety of industries.

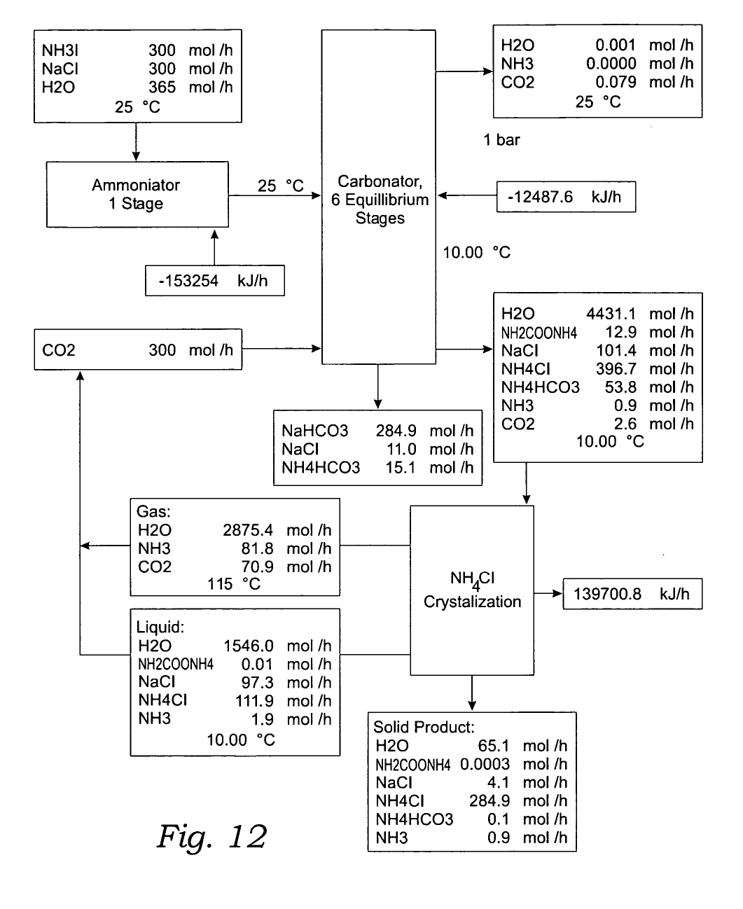

Meanwhile, ammonium chloride also has valuable purposes. For example, soda ash made by the Solvay Process of Modified Solvay Process, as illustrated in FIG. 12, is very important to the economy of nations lacking the ability to buy Wyoming Soda Ash. The sodium chloride recovered as a mix with ammonium can be used directly for making soda ash and the by-product ammonium chloride which has been recycled to remove sodium from the irrigation drainage (or salty waste water or salty groundwater).

Various modifications of the present invention may be carried out without departing from the spirit and scope of the invention. For example, when a high ammonium content in the treated water is not required, the ammonium can be stripped to very low levels and recycled back to the ion exchange operation which greatly reduces the purchase of ammonium. Where the energy for stripping is gathered in a heat storage material such as sodium sulfate, or in a non-convective solar pond, this method for using ion exchange ammonium to remove unwanted salts from saline waters becomes a process of “virtual solar desalination”.

As described above, the exchange of ammonium ions for sodium ions turns formerly “saline water” into a beneficial solution of fertilizers. Also, the hydroxyl ion formed when anhydrous ammonia is dissolved in water can be used in anion exchange to reduce the concentration of chloride and sulfate ions in acidic waters and convert the solution of ammonium hydroxide to a solution of ammonium fertilizers for cation exchange to reduce sodium, or for direct use as fertilizer.

### Additional Preferred Embodiments of the Present Invention

Though the above described methods for removing unwanted salts is preferred for many applications, additional methods of reducing salts, and preferably sodium, are acceptable and within the scope of the invention. For example, different crops have different needs as to the supply and availability to the plant of nutrients. The pH of the soil moisture affects the solubility and availability of some forms in which nutrients occur and many crops grow best in a narrow range of pH values.

Plants utilize solar energy via photosynthesis to generate the energy required to extract water and nutrients from the soil moisture through the root membranes. This energy is measured by “osmotic pressure”.

The major salts have different degrees of effect. The total energy requirements are primarily determined by the salinity of the water; higher salinities require higher energy to extract water and nutrients. The salt tolerance of plants is determined by genetics, both natural or as improved by plant scientists. The extreme variations in minerals from which the clays and soils are derived, the historical climate and rain fall, and the current climate and rainfall, present an infinite variety of conditions requiring a selection of appropriate water treatment from a very wide range of experiences. Investigations of this myriad of conditions has resulted in the selection of a few “measuring sticks” that, taken in combination, have been found to be beneficial in almost any set of conditions.

Clays are ion exchange materials and their physical properties are greatly dependent on the type and amount of clays present. Different soils have different needs for cations of (primarily), calcium, magnesium, and sodium. The practical effects of the total amount and relative amounts of each cation are calculated according to the percentage of the ion exchange sites on clay particles that are occupied by sodium ions as compared with the number of sites occupied by calcium and magnesium ions combined. This universally used calculation, which is not linear, is known as the Sodium Absorption Ratio (SAR).

As explained in greater detail below, a principal objective of the present invention is the selective removal and/or addition of cations in amounts necessary to optimize the “exchangeable sodium percentage” (ESP), as estimated from calculation of the “sodium adsorption ratio” (SAR). Notably, the ESP value alone is insufficient for predicting soil stability. Soil structure depends on many other factors, including soil salinity, tillage, mineralogy, organic matter, and pH. A second principal effect is the use of common agricultural raw materials in ways that do not increase the salinity, and often decrease the salinity, of irrigation water and soil moisture as measured by total dissolved solids (TDS).

The combined effects of optimization of SAR and control of soil salinity are:

1) optimizing SAR allows best infiltration or irrigation water with corresponding reduction in losses to runoff and evaporation optimizing SAR provides hydraulic conductivity to the soil for ease of root growth and movement of soil moisture with dissolved nutrients to the roots, and 2) reduction in the TDS of soil moisture lowers the osmotic pressure and reduces the amount of energy that plants use to extract water and selected nutrients from soil moisture. Lowering the TDS by reducing the sodium content reduces the need for leach water and reduces the contamination of ground water and connected surface water.

Field measurements use the current carrying capacity of soil moisture which is proportional to the concentrations of ions in the solution. This measurement is taken by instruments and corrected for cell geometry. Allowing all data to be reported as Electrical Conductance (EC). Approximations of total salinity of soil moisture are made using correlations from experience, typically that EC×0.64=Total Dissolved Solids (TDS). Adjustment of this factor up or down from 0.64 according to experience in local conditions is common. The wide variety of soils, water supplies and crops requires a wide variety of options.

Sulfur has been found to be a required soil nutrient in some locations. For example, a study conducted by the Tennessee Valley Authority found that farmers downstream from coal burning power plants increased their additions of sulfur after the power plants reduced their emissions of sulfur dioxide. Arid soils are also usually somewhat alkaline and sulfates of iron, magnesium, potassium, ammonium, etc. have been used to supply sulfur to the soil.

Meanwhile, we have found a very wide variety of options which can be derived from the use of materials common in making fertilizers and in amendments for agricultural soils. These are the acids used in rendering volatile and alkaline ammonia or ammonium hydroxide into materials of near neutral pH and or low volatility. Applicant has found that by changing the deionization process from an anion exchange with strong base resin regenerated with sodium hydroxide to a weak base resin regenerated with ammonium hydroxide, the contaminated feed water, after undergoing exchange of hydrogen for other cations, is converted to a slightly lower quality of deionized water but a water that it still of premium quality for irrigation and many industrial uses.

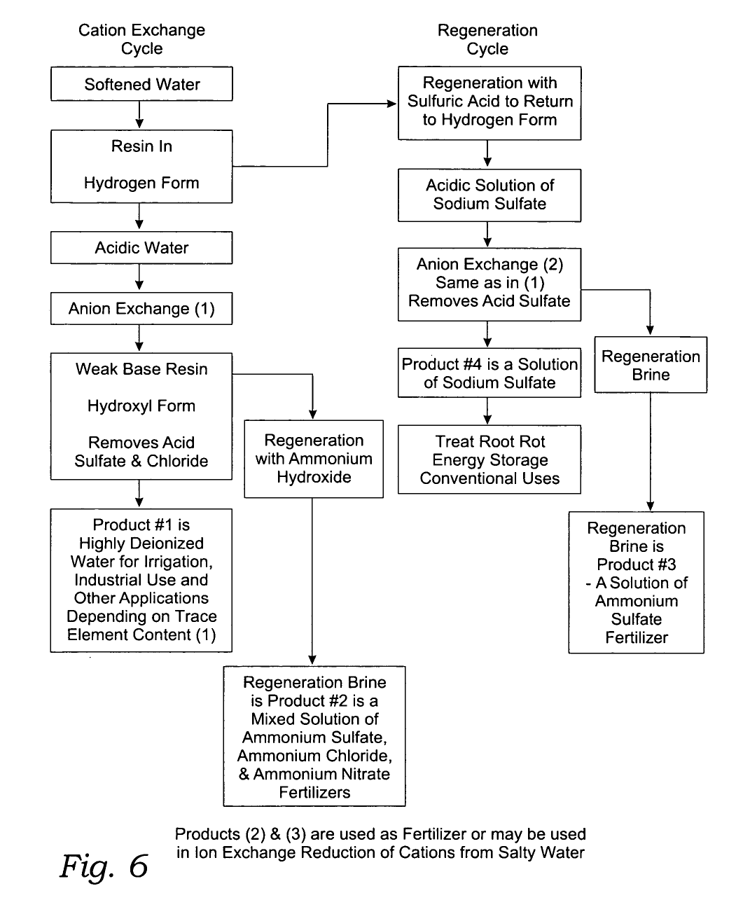

For this embodiment of the invention, the method of processing the waste water includes sequential steps of cation and anion exchange that utilizes a dual bed deionizing system. Specifically, deionizers may be categorized as a “mixed bed” system in which a single vessel holds both a cation and anion resin, or a “dual bed” system in which cation and anion resins are held in separate vessels. With reference to the first column of FIG. 6, though not necessary, preferably the waste water is initially softened prior to desalination. The water softening process results in the exchange of sodium for calcium, magnesium, iron and other divalent ions to produce an effluent high in sodium content. Thereafter, the sodium rich water is passed through the first of the two ion exchange vessels. The first vessel contains an acid cation resin which is saturated with hydrogen from hydrochloric, nitric, or preferably sulfuric acid. As the water passes through the cation exchange resin, the hydrogen is then exchanged with sodium.

As would be understood by those skilled in the art, if acids other that sulfuric acid are utilized, the anion component of the salt recovered from the acid regeneration brine from cation removal, will be the same as the anion used in the exchange process. For example, a nitrate will be recovered if the resin is saturated with hydrogen from nitric acid, etc. Where the weak acid cation is sulfuric acid, the sulfuric acid rich water is then passed through the second vessel providing anion exchange. The second vessel contains a weak basic resin saturated with hydroxyl from ammonium hydroxide made by dissolving anhydrous ammonia. With reference to FIG. 6, as the acid rich water is passed through the hydroxyl saturated resin, the hydroxyl ion is exchanged for the sulfates, chlorides, nitrites and nitrates to produce a useful effluent having decreased sulfates, chlorides, nitrites and nitrates. The resulting effluent, which is referred to as “product # 1” in FIG. 6, and as an ammonium rich water, is a highly deionized water. It is suitable for irrigation, for cooling towers, and other industrial uses and other applications. Further, depending upon purification levels and trace cation levels, such as arsenic, the resulting effluent may be of potable quality suitable for animal, including human, consumption.

Both of the dual-bed deionizers must be regenerated. With reference to the second column of FIG. 6, once the first ion exchange resin has become saturated with sodium ions, the resin is flushed with a regeneration fluid of 1% or more, and preferably 7-15% or more, of hydrochloric, nitric, or sulfuric acid to regenerate the resin to an acid cation form saturated with hydrogen. Thus, where the regenerative fluid is saturated with sulfuric acid the resulting effluent is an acidic solution of sodium sulfate. Preferably, the acidic sodium sulfate solution is also processed through an ion exchange process in which the resin is also pre-saturated with hydroxyl ions from a solution of anhydrous ammonia, to remove sulfate ions and produce an effluent, referred to as “product # 4” in FIG. 6. This product is rich in sodium sulfate and can be used to treat root rot, or for other uses as described above.

With reference to columns 1 and 2 of FIG. 6, once the ion exchange weak base resins become saturated with chloride and sulfate ions, the resins are flushed with a regenerative solution of 1% or more, and preferably 7-15% or more, of ammonium hydroxide. The flush continues until the ion exchange resin is sufficiently saturated with hydroxyl ions to again process the acidic water. As a result of regenerating two separate ion exchange beds, two additional regeneration brines are produced. The regeneration brine referred to as “product # 2” in FIG. 6 is a mixed solution of ammonium sulfate and ammonium chloride. Meanwhile, the regeneration brine referred to as “product # 3” in FIG. 6 is a solution rich in ammonium sulfate. Both regeneration brines are suitable for fertilizers, or may be used in separate ion exchange processes to remove cations from salty water.

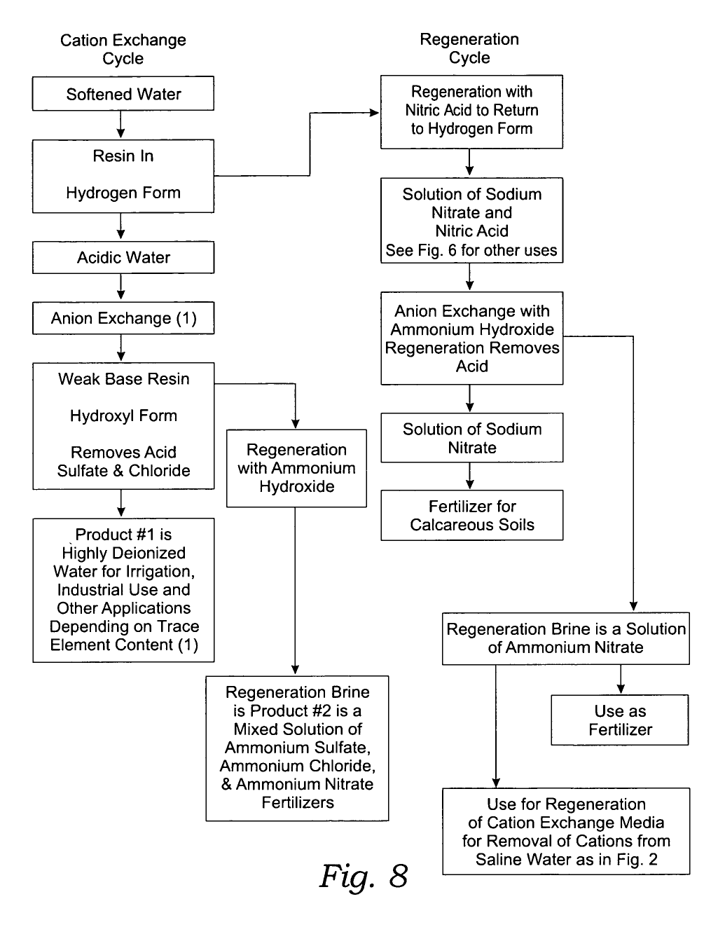

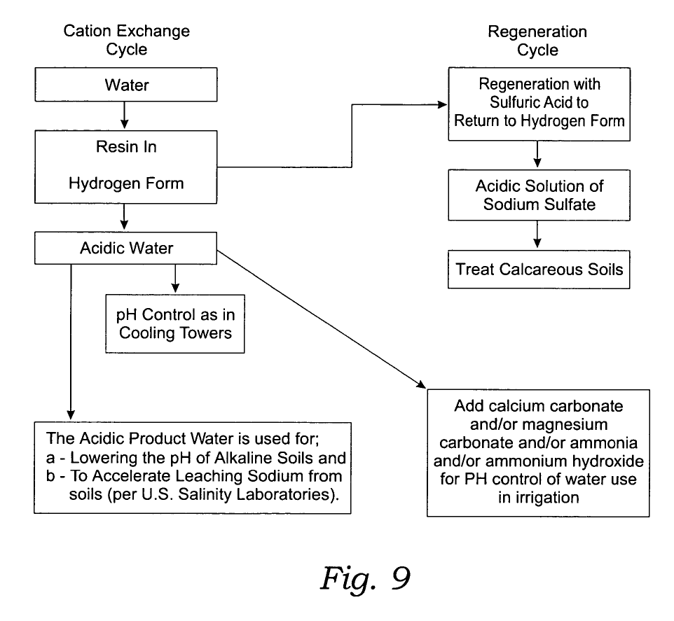

More specifically, I have found that contaminated water can be purified by first passing the water through a bed of cation exchange media, in the acid form as regenerated, using a solution of any of ammonium chloride, or ammonium nitrate, or ammonium sulfate which removes the cations. This step is followed by: 1) adding anhydrous ammonia to the now acidic treated water to partly or fully neutralize the acid and create a solution of ammonium fertilizers of low volatility, as shown in FIGS. 8 and 9, or 2) passing the now acidic water through a bed of anion exchange media in the hydroxyl form as regenerated using aqueous ammonium which exchange removes anions, with the result that the formerly contaminated water is highly purified and essentially all of the acid and all of the ammonia are converted to solutions of the less volatile (and more valuable) fertilizers such as ammonium chloride, ammonium nitrate, or ammonium sulfate and at a very high recovery of water used in building the regeneration fluids, as shown in the Preferred Flowsheets of FIGS. 6 & 7.

The advantages of the process of the present invention lie in the fact that all of the acids and ammonium end up as stable ammonium fertilizers for less cost than the price of purchasing ammonium sulfate and ammonium chloride. Moreover, the process illustrated in FIG. 6 results in all effluents and brines being useful. Only the water which may be evaporated from the sodium sulfate solution identified as product 4 is not recycled. Even then, there is the option for chilling out the sulfate as crystals of decahydrate to leave a liquid having a low salt content which is useful for various applications.

Still additional modifications of the process may be made without departing from the spirit and scope of the invention. For example, as stated above, hydrochloric and nitric acids may be substituted for sulfuric acid in the first of the dual bed deionizers. However, sulfuric acid is considered preferable because the resulting product #4 of sodium sulfate is more useful than sodium chloride, and the resulting product # 3 of ammonium sulfate is more useful as a fertilizer. The disadvantage of using sulfuric acid is that when the calcium content is high, it must first be removed by softening in order to avoid forming insoluble precipitate gypsum, or one must start the regeneration with a very dilute solution of sulfuric acid 1.0-2.5%, and gradually increase the concentration.

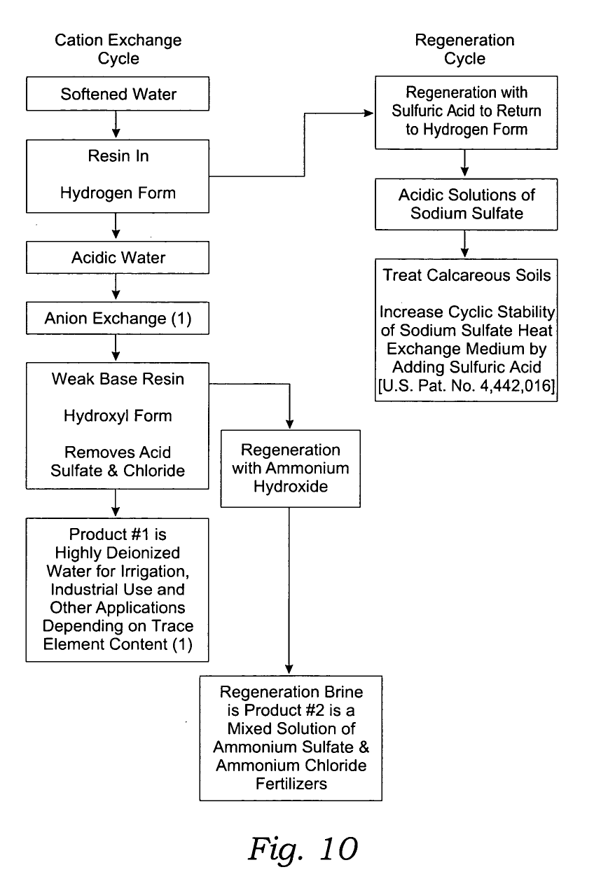

As illustrated, each of the various processes of FIGS. 6-10 provide ways of removing excess sodium in a manner that produces beneficial byproducts. The processes may also be implemented to produce tailored fertilizer products which can be altered depending on the characteristics of the soil and plants.

There are still additional uses of ammonium hydroxide, ammonium carbonate, ammonium chloride, ammonium nitrate, ammonium sulfate, and/or mixtures of these ammonium salt fertilizers, and/or hydrochloric acid, nitric acid, sulfuric acids and/or mixtures of these acids in purification of water with TDS above 500 ppm. The products are the sodium salt of the acid used plus water with reduced TDS and reduced SAR fertilized water. The use of either hydrochloric, nitric, or sulfuric acid, or mixtures of these acids, in the preferred process produces water with many non-potable uses in addition to irrigation. For example, the process illustrated in FIG. 6 uses sulfuric acid which is preferred for the lowest cost in recycling of high TDS water which makes softening worthwhile as a pretreatment for deionization with acid and ammonia, and there is a market for higher value sodium sulfate.

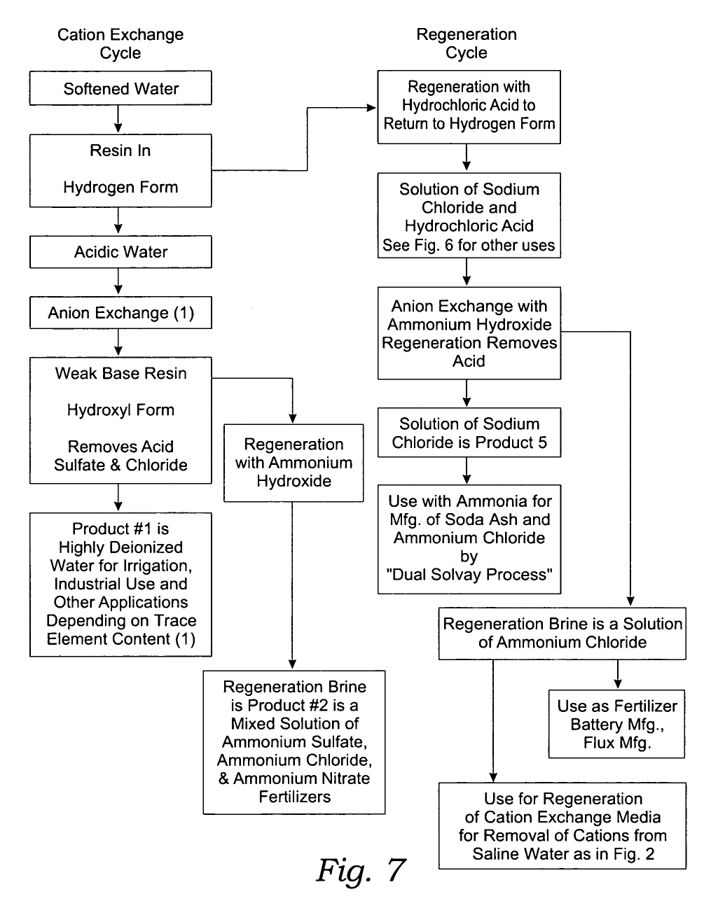

The process illustrated in FIG. 7 uses hydrochloric acid and ammonia which is preferred where the calcium and magnesium contents of the saline water are lower and not worth the extra costs of separation by softening. This is also the preferred process where ammonium chloride is a preferred product. This is also the preferred process where ammonium chloride is needed for making soda ash and the co-product ammonium chloride is in demand. For example, it has been found that the sodium chloride solution produced by the anion exchange with ammonium hydroxide can be processed in a Solvay Process to produce soda ash and ammonium chloride. The various Solvay processes are known to those skilled in the art including the traditional Solvay Process and Dual Solvay Process. Meanwhile, an acceptable modified Solvay Process is illustrated in FIG. 12.

The process shown in FIG. 8 uses nitric acid and ammonia and is preferred for crops where added sodium is beneficial to the soils. The process illustrated in the flow chart of FIG. 9 can be employed with or without the initial step of water. Use of ion exchange with acid regeneration provides a reduction in Total Dissolved Solids (TDS) with a simultaneous decrease in the Sodium Absorption Ration (SAR). The acidic water may be used for lowering the pH of water and soils and to aid in leaching sodium. Anhydrous ammonia as a gas or in solution ammonium hydroxide is used to stabilize water at a give pH level while adding nitrogen fertilizer with the low vapor pressure to minimize losses to the atmosphere.

Examples of processing moderately saline water in accordance with the processes shown in FIGS. 6-8 include the following. Brackish groundwater from Wonder Valley east of Twenty Nine Palms, Calif. is processed by passing the water through a dual bed deionizing system. The water has an initial salinity of 2000 mg/L which is reduced to 30 mg/L. In addition, irrigation drainage water from the San Joaquin Valley, Calif. has a pre-processed salinity of 7500 mg/L. Subsequent to processing, the purified water has a salinity of 80 mg/L.

While several particular forms of the invention have been illustrated and described, it will be apparent that various modifications can be made without departing from the spirit and scope of the invention.

I claim:

1. A method of treating water using a dual bed cation and anion exchange system comprising the steps of:
providing moderately saline water having substantially 0.05% or more by weight of the salts of Na, K, Ca, Mg, Fe, Cl, SO₄, or CO₃ or combinations thereof;
providing a first ion exchange media saturated with acids of hydrochloric acid, nitric acid or sulfuric acid, or combinations thereof;
passing the moderately saline water through the first ion exchange media to produce an acid rich water having less sodium than the moderately saline water;
providing a second ion exchange media saturated with ammonium hydroxide; and
passing the acid rich water through the second ion exchange media to produce purified water having decreased chloride, sulfate, nitrate, and nitrite anions.

2. The method of treating water using a dual bed cation and anion exchange system of claim 1 further comprising the step of providing the purified water to animals for consumption.

3. The method of treating water using a dual bed cation and anion exchange system of claim 1 further comprising the step of applying the purified water to soil.

4. The method of treating water using a dual bed cation and anion exchange system of claim 1 further comprising the step of using the purified water within cooling towers.

5. The method of treating water using a dual bed cation and anion exchange system of claim 1 further comprising the steps of:
providing a first regenerative solution having more than 1.00% by weight of hydrochloric acid, nitric acid or sulfuric acid, or combinations thereof; and
flushing the first ion exchange media and increasing the amount of hydrochloric acid, nitric acid or sulfuric acid affixed to first ion exchange media by passing the first regenerative solution through the first ion exchange media to also produce a first regenerative effluent.

6. The method of treating water using a dual bed cation and anion exchange system of claim 5 further comprising the step of applying the first regenerative effluent to soil.

7. The method of treating water using a dual bed cation and anion exchange system of claim 1 further comprising the steps of:
providing a second regenerative solution having more than 1.00% by weight of ammonium hydroxide; and
flushing the second ion exchange media and increasing the amount of ammonium hydroxide affixed to the second ion exchange media by passing the second regenerative solution through the second ion exchange media to produce a second regenerative effluent.

8. The method of treating water using a dual bed cation and anion exchange system of claim 7 further comprising the step of applying the second regenerative effluent to soil.

9. The method of treating water using a dual bed cation and anion exchange system of claim 1 further comprising the step of:
softening the moderately saline water prior to passing the moderately saline water through the first ion exchange media to reduce the moderately saline water's calcium and magnesium content, but increase the moderately saline water's sodium content.

10. The method of treating water using a dual bed cation and anion exchange system of claim 9 further comprising the step of applying the purified water to soil.

11. The method of treating water using a dual bed cation and anion exchange system of claim 1 wherein the first ion exchange media is saturated primarily with sulfuric acid.

12. The method of treating water using a dual bed cation and anion exchange system of claim 1 wherein the first ion exchange media is saturated primarily with nitric acid.

13. The method of treating water using a dual bed cation and anion exchange system of claim 1 wherein the first ion exchange media is saturated primarily with hydrochloric acid.

14. A method of treating water comprising the steps of:
providing moderately saline water having substantially 0.05% or more by weight of the salts of Na, K, Ca, Mg, Fe, Cl, SO₄, or CO₃ or combinations thereof;
providing an ion exchange media saturated with ammonium salts;
passing the moderately saline water through the ion exchange media to produce a useful effluent having more ammonium salts and less sodium than the moderately saline water; and
utilizing the useful effluent.

15. The method of treating water of claim 14 further comprising the steps of:
providing a regenerative solution having more than 1.00% by weight of ammonium salts; and
flushing the ion exchange media and increasing the amount of ammonium salts affixed to ion exchange media by passing the regenerative solution through the ion exchange media.

16. The method of treating water of claim 14 wherein said ion exchange media includes zeolite or synthetic zeolite.

17. The method of treating water of claim 14 wherein said step of utilizing the useful effluent includes applying the useful effluent to soil.

18. The method of treating water of claim 14 further comprising the step of:
softening the moderately saline water prior to passing the moderately saline water through the ion exchange media to reduce the moderately saline water's calcium and magnesium content, but increase the moderately saline water's sodium content.

19. The method of treating water of claim 18 further comprising the steps of:
providing a regenerative solution having more than 1.00% by weight of the ammonium salt; and
flushing the ion exchange media and increasing the amount of ammonium salts affixed to ion exchange media by passing the regenerative solution through the ion exchange media.

20. The method of treating water of claim 19 wherein said step of utilizing the useful effluent includes applying the useful effluent to soil.
